(19) United States
(12) Patent Application Publication
(10) Pub. No.: US 2023/0123391 A1
(43) Pub. Date: Apr. 20, 2023

(54) TEA SPIRIT AND METHOD FOR PREPARING THE SAME

(71) Applicants: Luzhou LaoJiao Co., Ltd., Luzhou (CN); Luzhou Pinchuang Technology Co., Ltd., Luzhou (CN)

(72) Inventors: Caihong SHEN, Luzhou (CN); Miao LIU, Luzhou (CN); Feng LIN, Luzhou (CN); Huafang FENG, Luzhou (CN); Yu LAN, Luzhou (CN); Xiaonian CAO, Luzhou (CN); Qingqing LIU, Luzhou (CN); Xiaogang LIU, Luzhou (CN); Yanfei XIONG, Luzhou (CN); Yong WAN, Luzhou (CN); Yong YANG, Luzhou (CN); Tianchi CAO, Luzhou (CN); Xudong ZHAO, Luzhou (CN); Songtao WANG, Luzhou (CN); Bo DENG, Luzhou (CN); Lei ZHENG, Luzhou (CN); Xiangyun LEI, Luzhou (CN); Tao ZHENG, Luzhou (CN)

(21) Appl. No.: 17/970,247

(22) Filed: Oct. 20, 2022

(30) Foreign Application Priority Data
Oct. 20, 2021 (CN) 202111221057.0

(51) Int. Cl. C12G 3/055; A23F 3/22; A23F 3/42; A23F 3/18; C12G 3/06

(52) U.S. Cl. CPC C12G 3/055; A23F 3/22; A23F 3/426; A23F 3/18; C12G 3/06

(57) ABSTRACT

A tea spirit and a method for preparing the same are provided. The method comprises steps crushing tea leaves and soaking the crushed tea leaves in a solvent to obtain a tea suspension; subjecting the tea suspension to distillation under reduced pressure to obtain a tea aroma extract and a remaining tea pulp; filtering the tea pulp to obtain a tea soup, and subjecting the tea soup to concentration under reduced pressure and filtering the tea soup to obtain a filtrate; adsorbing the filtrate with macroporous adsorption resin, then adding food-grade anhydrous alcohol, letting the resultant mixture stand, separating solid from the mixture and drying the solid to obtain a tea theanine extract; and mixing the tea aroma extract and the tea theanine extract with Chinese baijiu to obtain the tea wine. The tea wine as obtained has both tea aroma and wine aroma, and also has an improved intoxication tolerance time.

### CROSS-REFERENCE TO RELATED APPLICATIONS

This application claims the priority to Chinese Patent Application No. 202111221057.0, filed on Oct. 20, 2021, the disclosure of which is hereby incorporated by reference herein in its entirety.

### TECHNICAL FIELD

The present disclosure relates to the field of alcoholic beverage technologies, and specifically relates to a tea wine and a method for preparing the same.

### BACKGROUND

Both wine and tea are special traditional foods, which are not only material foods, but also integrated into people's spiritual life. With the gradual development of our country's tea culture and wine industry, as well as people's further demand for a diversified and healthy life, research on tea wine has emerged. The development of tea wine can not only make full use of tea resources and broaden the tea industry, but also enrich the diversity of wine products, which is of great significance to the promotion of the economic development of our country.

“Tea wine” refers to the general term of integrated alcoholic beverages (or alcoholic drinks mixed with fruit juice or medicinal food) prepared by extraction, redistillation or fermentation of tea and wine as the main raw materials. Among six major tea categories, all types of tea have different flavor characteristics, among which black tea has a sweet, floral and fruity fragrance; oolong tea highlights the pleasant, layered floral fragrance. Secondly, tea is also rich in functional active components, mainly including theanine, linalool, geraniol, methyl salicylate and so on. These components have outstanding health activities. For example, theanine is the main ingredient of tea to enrich the saliva and sweetness. It has the functions of improving human immunity, anti-depression, lowering blood pressure, eliminating fatigue, and affecting the expressions of neurotransmitters in the brain; linalool has anti-depression, anti-tumor, anti-oxidation, liver protection and other effects; geraniol has anti-inflammatory, antibacterial (especially anti-fungal), anti-cancer, and analgesic effects, and has a good effect on chronic bronchitis and bronchial asthma; methyl salicylate has anti-inflammatory and analgesic effects. These functional components have high economic value, and their separation and extraction can effectively improve the comprehensive utilization rate of tea raw materials. Incorporating these functional components into Chinese baijiu (i.e., liquor) to make tea wine will further enhance the important value of tea and Chinese baijiu.

At present, the tea wine on the market is mostly fermented wine or distilled wine formed by fermentation of tea and fermented grains together; or prepared by extracting tea leaves with alcoholic beverages; or prepared by adding tea powder, tea polyphenols, tea polysaccharides, theanine and other functional components, to ensure its efficacy. However, there is still a lack of tea wine that has both the aroma of tea and wine, and at the same time has an improved intoxication tolerance time.

### SUMMARY

In view of this, an aspect of the present disclosure aims to provide a method for preparing a tea wine by simple and easy operations, the tea wine as prepared not only has pleasant tea aroma and wine aroma, but also has an improved intoxication tolerance time so that a drinker is not easy to get drunk.

Specifically, the method for preparing the tea wine according to the present disclosure comprises the following steps:

(1) crushing tea leaves and soaking the crushed tea leaves in a solvent to obtain a suspension of the tea leaves;

(2) subjecting the suspension of the tea leaves to distillation under reduced pressure to obtain a tea aroma extract and a remaining tea pulp;

(3) filtering the tea pulp to obtain a tea soup, and subjecting the tea soup to concentration under reduced pressure and filtering the tea soup to obtain a filtrate;

(4) adsorbing the filtrate with macroporous adsorption resin, then adding food-grade anhydrous alcohol, letting the resultant mixture stand, and separating solid from the mixture and drying the solid to obtain a tea theanine extract; and

(5) mixing the tea aroma extract and the tea theanine extract with Chinese baijiu to obtain the tea wine.

The method for preparing the tea wine according to the present disclosure, the solvent in step (1) may be pure water. Preferably, the electrical conductivity of the pure water is 1-10 μs/cm. Preferably, the weight of the pure water is 4-20 times the weight of the tea leaves.

The method for preparing the tea wine according to the present disclosure, the soaking in step (1) may be performed at a temperature of 60-90° C. Preferably, the soaking time is 0.5-2 hours.

The method for preparing the tea wine according to the present disclosure, the distillation under reduced pressure in step (2) may be performed at a pressure of 30-76 Kpa.

The method for preparing the tea wine according to the present disclosure, the distillation under reduced pressure in step (2) may be performed at a temperature of 65-90° C.

The method for preparing the tea wine according to the present disclosure, the temperature of condensed water used in the distillation under reduced pressure in step (2) is 2-8° C.

The method for preparing the tea wine according to the present disclosure, the tea aroma extract comprises one or more of linalool, geraniol, and methyl salicylate.

The method for preparing the tea wine according to the present disclosure, in the tea aroma extract, a content of the linalool is 1.0-3.0 μg/ml, a content of the geraniol is 0.5-3.0 μg/ml, and/or a content of the methyl salicylate is 1.5-3.0 μg/ml.

The method for preparing the tea wine according to the present disclosure, in step (3), the tea pulp is filtered by means of a horizontal decanter centrifuge. Preferably, the rotation speed of the horizontal decanter centrifuge is 1000-4000 rpm.

The method for preparing the tea wine according to the present disclosure, in step (3), the tea soup is subjected to the concentration under reduced pressure at a vacuum degree of 76-85 Kpa and a temperature of 55° C.-65° C. Preferably, the tea soup is concentrated under reduced temperature to have a volume that is ⅕-½ of the original volume of the tea soup.

The method for preparing the tea wine according to the present disclosure, in step (3), the tea soup is subjected to concentration under reduced pressure under reduced pressure followed by micro-filtration and ultrafiltration in sequence; and preferably, the micro-filtration is performed with a ceramic membrane with a pore diameter of 0.1-0.5 μm and preferably at a temperature of 20-30° C.

The method for preparing the tea wine according to the present disclosure, in step (4), the filtrate is statically adsorbed with the macroporous adsorption resin which is D101 macroporous adsorption resin and/or AB-8 macroporous adsorption resin.

The method for preparing the tea wine according to the present disclosure, the purity of the anhydrous alcohol in step (4) is 95% or more, and the volume of the anhydrous alcohol is 2-10 times the volume of the filtrate adsorbed with the macroporous adsorption resin.

The method for preparing the tea wine according to the present disclosure, the alcohol content (v/v) of the Chinese baijiu in step (5) is 20-60%; the Chinese baijiu is preferably a strong-flavor Chinese baijiu.

The method for preparing the tea wine according to the present disclosure, the tea leaves used are at least one of black tea, oolong tea, and jasmine tea.

The method for preparing the tea wine according to the present disclosure, the method does not comprise a step of fermenting the tea leaves.

Another aspect of the present disclosure aims to provide a tea wine prepared by the above method of the present disclosure.

The tea wine provided according to the present disclosure may contain 10-100 parts by weight of the tea aroma extract, 1-10 parts by weight of the tea theanine extract, and 380-480 parts by weight of Chinese baijiu.

Particularly, the tea wine provided according to the present disclosure, contains 10-100 parts by weight of the tea aroma extract, 1-10 parts by weight of the tea theanine extract, and 380-480 parts by weight of Chinese baijiu, based on a total of 500 parts by weight of the tea wine, and the balance is water.

The tea wine prepared according to the method for preparing a tea wine provided in the present disclosure contains tea aroma substances and tea theanine, and has pleasant tea aroma and wine aroma and tea taste. Moreover, the results of the intoxication test on mice for the tea wine prepared by the present disclosure show that compared with the pure Chinese baijiu of the control sample, the time for the loss of righting reflex of the mice was significantly increased, which suggests that the tea wine of the present disclosure has the effect of increasing the intoxication tolerance time.

### BRIEF DESCRIPTION OF THE DRAWINGS

FIG. 1 is a flowchart of a process for preparing a tea wine according to the present disclosure;

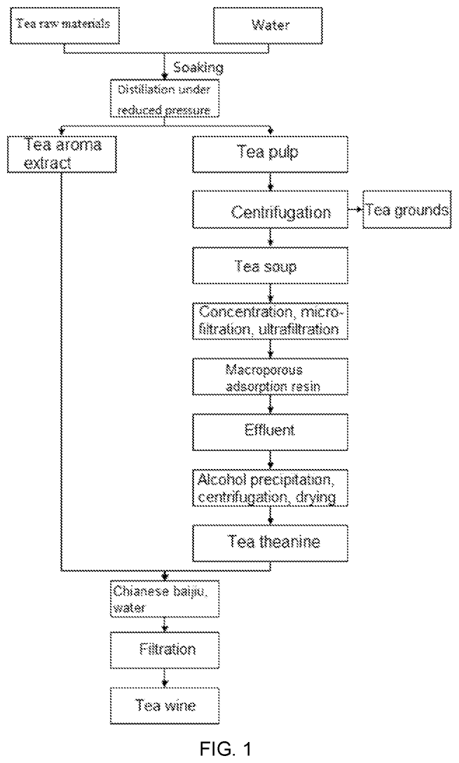

FIG. 2 is a gas chromatography-mass spectrometry chromatogram of a tea aroma extract prepared according to Example 1 of the present invention;

FIG. 3 is a gas chromatography-mass spectrometry chromatogram of a tea aroma extract prepared according to Example 2 of the present invention;

FIG. 4 is a gas chromatography-mass spectrometry chromatogram of a tea aroma extract prepared according to Example 3 of the present invention; and

FIG. 5 is a gas chromatography-mass spectrometry chromatogram of a tea aroma extract prepared according to Example 4 of the present invention.

### DETAILED DESCRIPTION

The embodiments of the present invention are described below by specific examples, and those skilled in the art can easily understand other advantages and effects of the present disclosure from the content disclosed in the description. The present disclosure can also be implemented or applied through other different specific examples, and various details in the description can also be modified or changed based on different viewpoints and applications without departing from the spirit of the present disclosure.

A method for preparing a tea wine provided in the present disclosure includes the following steps: (1) crushing tea leaves and soaking the crushed tea leaves in a solvent to obtain a tea suspension; (2) subjecting the tea suspension to distillation under reduced pressure to obtain a tea aroma extract and a remaining tea pulp; (3) filtering the tea pulp to obtain a tea soup, and subjecting the tea soup to concentration under reduced pressure and filtering the tea soup to obtain a filtrate; (4) statically adsorbing the filtrate with macroporous adsorption resin, then adding food-grade anhydrous alcohol, letting the resultant mixture stand, separating solid from the mixture and drying the solid to obtain a tea theanine extract; and (5) mixing the tea aroma extract and the tea theanine extract with Chinese baijiu to obtain the tea wine.

The tea wine of the present disclosure having both tea aroma and Chinese baijiu aroma can be obtained by extracting high-purity tea aroma extract and tea theanine extract from tea leaves and then blending them with Chinese baijiu. Moreover, the tea wine also advantageously has an improved intoxication tolerance time, so that in daily life, after drinking the tea wine, people can get a sense of physical and mental pleasure, and at the same time, they are not easy to get drunk.

The tea leaves used in the method for preparing the tea wine of the present disclosure may not be particularly limited, and may be, for example, at least one of black tea, oolong tea, and jasmine tea. Black tea highlights the sweet, floral and fruity fragrance; oolong tea highlights the pleasant, layered floral fragrance; jasmine tea has a long-lasting aroma, a mellow and refreshing taste, and a refreshing floral fragrance. The tea wine obtained by blending the aroma extract(s) of black tea, oolong tea and/or jasmine tea with Chinese baijiu is a pleasant and sweet smell-flavor integrated tea wine.

In step (1), tea leaves may be crushed by conventional methods, such as cutting or using a grinder. Advantageously, the tea leaves are crushed to a size in a range of 10-40 meshes, for example 20-35 meshes, so as to make sure that the tea aroma substances can be fully leached, but also facilitate the smooth proceeding of the processing process.

In step (1), the solvent used for mixing tea fragments is preferably pure water, more preferably, hot pure water, even more preferably, hot pure water at a temperature of 60-90° C., and more preferably, hot pure water at a temperature of 75-90° C. In the method for preparing the tea wine of the present disclosure, the solvent used for soaking the tea leaves may not contain an organic solvent such as ethanol, and may be, for example, pure water.

In the case that the solvent is pure water, the crushed tea leaves are preferably soaked at a temperature of 60-90° C., particularly 75-90° C. Soaking the crushed tea leaves at a temperature within this range can maintain the aroma components of the tea leaves as much as possible without losing them, meanwhile sufficiently leach the aroma components of the tea leaves.

Preferably, the conductivity of the pure water used in the present disclosure is 1-10 μs/cm, more preferably 3-8 μs/cm. Pure water having a conductivity within this range may be equivalent to industrial grade I reverse osmosis water, having less impurities. Therefore, it has been found that using said pure water may present better tea wine qualities.

Preferably, the weight of the pure water used in step (1) is 4-20 times, for example 8-14 times, the weight of the tea leaves. Preferably, the soaking time of the crushed tea leaves is 0.5-2 hours. Under these conditions, tea aroma substances may be sufficiently leached, and the processing time for subsequent distillation and concentration procedures may be saved.

In the present disclosure, the tea aroma extract extracted by concentration and distillation of tea leaves under reduced pressure is used for the preparation of tea wine, which may ensure that the obtained tea wine has a fragrant tea flavor. In step (2), the tea suspension is subjected to distillation under reduced pressure so as to obtain the tea aroma extract and leave the tea pulp. In particular, after continuous exploration, the inventor has found that the pressure at which the distillation is performed can affect the quality of the tea wine. The distillation under reduced pressure is preferably performed at a pressure of 30-76 Kpa, more preferably 40-70 Kpa, and still more preferably 43-68 Kpa.

The inventor has also found that the temperature at which the distillation under reduced pressure is performed can affect the quality of the tea wine. However, tea aroma substances are heat-sensitive substances, the distillation temperature should not be too high, otherwise material changes may occur, and the distillation temperature should not be too low, otherwise it will affect the extraction rate of the tea aroma substances. Considering the above and a mass of test data of the components in the tea aroma extract, in order to obtain a better tea aroma effect, the inventor controlled the distillation temperature at 65-90° C., preferably 70-87° C., and more preferably 75-85° C.

Further, the inventor has found that in a preferred embodiment, when the tea leaves are black tea, the distillation temperature is preferably 75-90° C., and more preferably 80-85° C.; and when the tea leaves are oolong tea and/or herbal tea, the distillation temperature is preferably 70-85° C., and more preferably 75-80° C.

In a preferred embodiment, the temperature of the condensed water used in the distillation under reduced pressure is 2-8° C., for example, 3-6° C.

The tea aroma extract extracted according to the method of the present disclosure contains one or more of linalool, geraniol, and methyl salicylate. In the tea aroma extract, the content of linalool is 1.0-3.0 μg/ml, such as 1.3-2.9 μg/ml or 1.5-2.5 μg/ml, the content of geraniol is 0.5-3.0 μg/ml, such as 0.6-2.9 μg/ml or 0.8-2.1 μg/ml, and/or, the content of methyl salicylate is 1.5-3.0 μg/ml, such as 1.3-2.9 μg/ml or 1.8-2.5 μg/ml. In the tea aroma substance extraction method of the present disclosure, pure water is used as the solvent, and there is no need to add organic substances such as alcohol (ethanol) or other inorganic substances, and then by means of the process of distillation under reduced pressure, high-purity tea aroma extract with high content of tea aroma components is extracted from the tea leaves. That is, a “green” extraction method is used in the present disclosure to extract pure natural high-purity tea aroma extract, which ensures that the prepared tea wine has excellent aroma, taste and health functions.

Since the tea wine contains the natural tea aroma extract according to the present disclosure, the tea wine of the present disclosure has anti-depression, anti-tumor, anti-oxidation, liver protection, anti-inflammatory, antibacterial (especially fungal), anti-cancer, analgesic and other health care or therapeutic effects to a certain extent.

According to the method of the present disclosure, a naturally extracted theanine extract is also obtained by extracting theanine from the tea leaves, which may be blended with Chinese baijiu so that the tea wine may enrich the saliva and sweetness, and may improve human immunity, resist depression, lower blood pressure, eliminate fatigue, and affect the expression of neurotransmitting substances in the brain.

In the method for preparing a tea wine according to the present disclosure, in step (3), the tea pulp may be filtered by a conventional method, preferably by a horizontal decanter centrifuge, and the rotation speed of the horizontal decanter centrifuge is preferably 1000-4000 rpm.

In a preferred embodiment of the present invention, in step (3), the tea soup is subjected to concentration under reduced pressure at a temperature of 55-65° C. In a preferred embodiment of the present invention, in step (3), the tea soup is subjected to concentration under reduced pressure at a vacuum degree of 76-85 Kpa. Preferably, the tea soup is concentrated under reduced temperature to have a volume that is ⅕-½ of the original volume of the tea soup. The conditions for the concentration of the tea soup under reduced pressure is obtained by the inventor through a large number of experiments. Performing concentration under such conditions may help to obtain the tea theanine extract with higher purity in the subsequent processes, reduce the loss of theanine, while reducing the complexity of and the time consumed in the subsequent treatment processes.

After concentrating the tea soup under reduced pressure, micro-filtration and then ultrafiltration are performed to obtain a filtrate with almost no solid impurities. The micro-filtration is preferably performed with a ceramic membrane with a pore diameter of 0.1-0.5 μm, and is preferably performed at a temperature of 20-30° C. For example, ultrafiltration can be carried out with a multifunctional ultrafiltration membrane device equipped with an ultrafiltration membrane having a cut-off molecular weight of 10000 da-60000 da to remove substantially all particles.

The filtrate obtained through micro-filtration and/or ultrafiltration is statically adsorbed with a macroporous adsorption resin to further remove impurities in the filtrate, such as caffeine, through adsorption, so as to further improve the purity of the theanine extract obtained subsequently. D101 macroporous adsorption resin and/or AB-8 macroporous adsorption resin is preferably used for the macroporous adsorption resin.

Food-grade anhydrous alcohol is added to the filtrate statically adsorbed with the macroporous adsorption resin to precipitate theanine in the filtrate. The purity of the anhydrous alcohol is 95% or more, for example, 97% or more. The volume of the anhydrous alcohol is 2-10 times, for example, 4-8 times, the volume of the filtrate statically adsorbed with the macroporous adsorption resin.

The filtrate added with anhydrous alcohol is dwelled at room temperature to precipitate the solid, and then centrifuged and dried to obtain the tea theanine extract.

Only water and food-grade anhydrous alcohol are used in the theanine extraction process of the present disclosure, and no other solvents or additives are needed. Therefore, the obtained theanine extract does not contain other added components and can be directly used as food additives, which is beneficial to health.

Unlike conventional methods in the art, the present disclosure may not include the fermentation process of tea leaves in the process of extracting the tea aroma substance. That is, in the processes of concentration under reduced temperature and distillation of the tea leaves in step (1) of the method of the present disclosure, the tea leaves are not fermented, but only mixed with water, and then concentration under reduced pressure and distillation are performed. The tea leaves are directly concentrated under reduced temperature and distilled without fermentation to extract the tea aroma extract, which can retain and extract the true aroma of the tea leaves, and avoid the smell of other substances caused by the fermentation of the tea, and meanwhile, it is avoided that other substances are produced in the remaining tea leaves and carried into the subsequent steps, thereby affecting the extraction and purity of the aroma components of the tea.

The alcohol content (v/v) of Chinese baijiu used in the method for preparing the tea wine in the present disclosure may be 20-60%, such as 30-60% or 40-55%. The Chinese baijiu may be Chinese baijiu with strong flavor, Chinese baijiu with sauce-flavor, Chinese baijiu with fresh flavor, and Chinese baijiu with rice flavor, among which the strong-flavor Chinese baijiu is preferred.

The method for preparing the tea wine in the present disclosure may further include the step of adjusting the alcohol content of the tea wine after adding the tea aroma extract and the tea theanine extract to Chinese baijiu. That is, when blending the tea wine, the alcohol content of the tea wine can be adjusted as needed.

According to a preferred embodiment of the present invention, the tea wine provided by the present disclosure contains 10-100 parts by weight of the tea aroma extract, 1-10 parts by weight of the tea theanine extract, and 380-480 parts by weight of Chinese baijiu. Preferably, the tea wine provided by the present disclosure contains 10-60 parts by weight of the tea aroma extract, 2-7 parts by weight of the tea theanine extract, and 420-480 parts by weight of Chinese baijiu. The tea aroma, tea taste, wine aroma and wine taste can be well balanced when the tea wine is prepared with such a proportion, and at the same time, the intoxication tolerance time is improved so that people can enjoy the fusion of the fragrance and taste of tea wine in a pleasant mood without getting drunk easily.

In a preferred embodiment of the present invention, the tea wine contains 10-100 parts by weight of the tea aroma extract, 1-10 parts by weight of the tea theanine extract, and 380-480 parts by weight of Chinese baijiu, based on a total of 500 parts by weight of the tea wine, and the balance is water. In a further preferred embodiment of the present invention, the tea wine contains 10-60 parts by weight of the tea aroma extract, 2-7 parts by weight of the tea theanine extract, and 420-480 parts by weight of Chinese baijiu, based on a total of 500 parts by weight of the tea wine, and the balance is water. It should be understood that in this case, the tea wine contains no or almost no other components; in other words, in this case, the tea wine contains 1.0% or less or 0.5% or less of any other components than the above-mentioned substances.

### EXAMPLES

The present disclosure will be further explained through specific examples below. It should be understood that the scope of the present disclosure is not limited to the following examples.

The process equipment or devices not specifically noted in the following examples are all conventional equipment or devices in the art. The methods used in the present disclosure, unless otherwise specified, are conventional methods in the field; the raw materials and auxiliary materials used in the present disclosure, unless otherwise specified, are all conventional raw materials and auxiliary materials in the field.

The gas chromatography-mass spectrometer used in the following examples is Agilent 7890A-5975C.

### Example 1

Black tea leaves were crushed to have a size of 40 meshes, and the crushed tea leaves were soaked in pure water having a weight 4 times the weight of the tea leaves, for 1 hour. The conductivity of the pure water was 1-5 μs/cm, and the temperature of the pure water was 85° C.

The suspension obtained after soaking the tea leaves was extracted by distillation under reduced pressure to obtain a tea aroma extract, and tea pulp was left. The distillation under reduced pressure was carried out at a vacuum degree of 54 Kpa and at a distillation extraction temperature of 80° C., and the temperature of condensed water was 5° C.

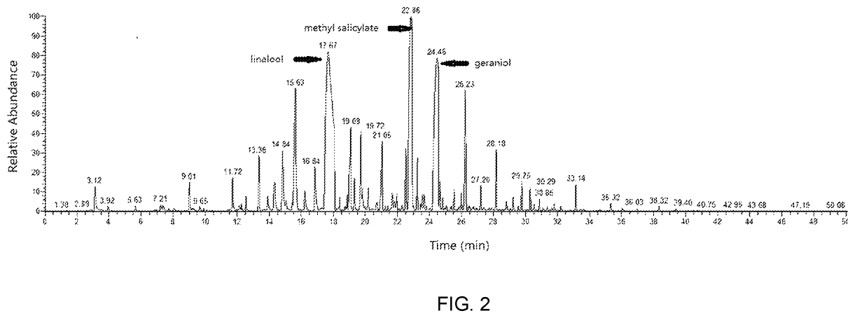

Aroma substances of the tea aroma extract extracted above were detected and analyzed with a gas chromatography-mass spectrometer, and the analysis chromatogram is shown in FIG. 2. The content of linalool in the tea aroma extract was measured as 1.824 μg/ml, the content of geraniol was 2.947 μg/ml, and the content of methyl salicylate was 2.942 μg/ml.

The tea pulp obtained above was centrifuged in a horizontal decanter centrifuge at a centrifugal speed of 3000 rpm, and filtered. The liquid was concentrated under reduced temperature at a vacuum degree of 81 Kpa and a temperature of 60° C., to have a volume that was ⅖ of its original volume, and then micro-filtration was performed at 23° C. with a ceramic membrane having a pore size of 0.2 μm, followed by ultrafiltration, to obtain a filtrate.

The filtrate obtained above was statically adsorbed with macroporous adsorption resin AB-8. 95% food-grade anhydrous alcohol solution having a volume 8.5 times the volume of the filtrate was added to the adsorbed filtrate; and the solution was precipitated at room temperature, centrifuged, and dried to obtain a tea theanine extract. The purity of the tea theanine extract was 50% as measured by high performance liquid chromatography.

The extracted tea aroma extract and tea theanine extract were added to and mixed well with Chinese baijiu. The Chinese baijiu was of a strong-flavor type and had an alcohol content (v/v) of 40%. The tea wine contained 25 parts of the tea aroma extract, 2 parts of the tea theanine extract, 470 parts of Chinese baijiu, based on 500 parts by weight of tea wine, and the balance was water.

The tea wine prepared above can be subjected to processes of storage, filtration and packaging.

### Example 2

Black tea leaves were crushed to have a size of 25 meshes, and the crushed tea leaves were soaked in pure water having a weight 10 times the weight of the tea leaves, for 0.75 hours. The conductivity of the pure water was 1-5 μs/cm, and the temperature of the pure water was 85° C.

The suspension obtained after soaking the tea leaves was extracted by distillation under reduced pressure to obtain a tea aroma extract, and tea pulp was left. The distillation under reduced pressure was carried out at a vacuum degree of 43 Kpa and at a distillation extraction temperature of 85° C., and the temperature of condensed water was 3° C.

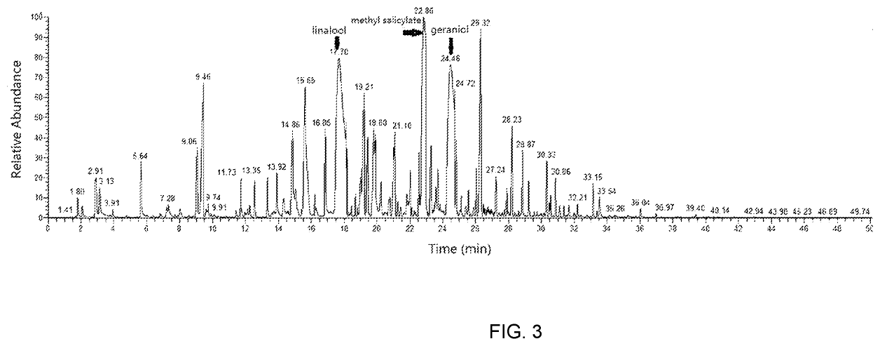

Aroma substances of the tea aroma extract extracted above were detected and analyzed with a gas chromatography-mass spectrometer, and the analysis chromatogram is shown in FIG. 3. The content of linalool in the tea aroma extract was measured as 2.234 μg/ml, the content of geraniol was 2.015 μg/ml, and the content of methyl salicylate was 1.600 μg/ml.

The tea pulp obtained above was centrifuged in a horizontal decanter centrifuge at a centrifugal speed of 3000 rpm, and filtered. The liquid was concentrated under reduced temperature at a vacuum degree of 81 Kpa and a temperature of 60° C., to have a volume that was ⅖ of its original volume, and then micro-filtration was performed at 23° C. with a ceramic membrane having a pore size of 0.2 μm, followed by ultrafiltration, to obtain a filtrate.

The filtrate obtained above was statically adsorbed with macroporous adsorption resin AB-8. 95% food-grade anhydrous alcohol solution having a volume 8.5 times the volume of the filtrate was added to the adsorbed filtrate; and the solution was precipitated at room temperature, centrifuged, and dried to obtain a tea theanine extract. The purity of the tea theanine extract was 46% as measured by a gas chromatography-mass spectrometer.

The extracted tea aroma extract and tea theanine extract were added to and mixed well with Chinese baijiu. The Chinese baijiu was of a strong-flavor type and had an alcohol content (v/v) of 40%. The tea wine contained 50 parts of the tea aroma extract, 3 parts of the tea theanine extract, 445 parts of Chinese baijiu, based on 500 parts by weight of tea wine, and the balance was water.

The tea wine prepared above can be subjected to processes of storage, filtration and packaging.

### Example 3

Jasmine tea leaves were crushed to have a size of 60 meshes, and the crushed tea leaves were soaked in pure water having a weight 5 times the weight of the tea leaves, for 1 hour. The conductivity of the pure water was 1-5 μs/cm, and the temperature of the pure water was 85° C.

The suspension obtained after soaking the tea leaves was extracted by distillation under reduced pressure to obtain a tea aroma extract, and tea pulp was left. The distillation under reduced pressure was carried out at a vacuum degree of 61 Kpa and at a distillation extraction temperature of 76° C., and the temperature of condensed water was 6° C.

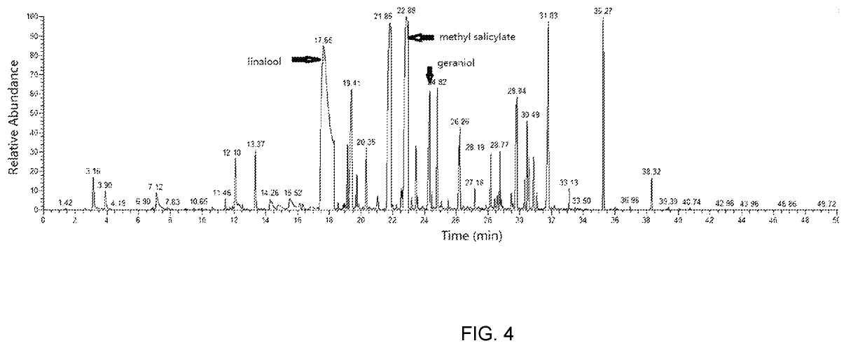

Aroma substances of the tea aroma extract extracted above were detected and analyzed with a gas chromatography-mass spectrometer, and the analysis chromatogram is shown in FIG. 4. The content of linalool in the tea aroma extract was measured as 1.300 μg/ml, the content of geraniol was 0.500 μg/ml, and the content of methyl salicylate was 1.604 μg/ml.

The tea pulp obtained above was centrifuged in a horizontal decanter centrifuge at a centrifugal speed of 3500 rpm, and filtered. The liquid was concentrated under reduced temperature at a vacuum degree of 85 Kpa and a temperature of 55° C., to have a volume that was ⅖ of its original volume, and then micro-filtration was performed at 22° C. with a ceramic membrane having a pore size of 0.1 μm, followed by ultrafiltration, to obtain a filtrate.

The filtrate obtained above was statically adsorbed with macroporous adsorption resin D101. 95% food-grade anhydrous alcohol solution having a volume 9 times the volume of the filtrate was added to the adsorbed filtrate; and the solution was precipitated at room temperature, centrifuged, and dried to obtain a tea theanine extract. The purity of the tea theanine extract was 40% as measured by a gas chromatography-mass spectrometer.

The extracted tea aroma extract and tea theanine extract were added to and mixed well with Chinese baijiu. The Chinese baijiu was of a strong-flavor type and had an alcohol content (v/v) of 40%. The tea wine contained 25 parts of the tea aroma extract, 3 parts of the tea theanine extract, 470 parts of Chinese baijiu, based on 500 parts by weight of tea wine, and the balance was water.

The tea wine prepared above can be subjected to processes of storage, filtration and packaging.

### Example 4

Jasmine tea leaves were crushed to have a size of 30 meshes, and the crushed tea leaves were soaked in pure water having a weight 10 times the weight of the tea leaves, for 1 hour. The conductivity of the pure water was 1-5 μs/cm, and the temperature of the pure water was 85° C.

The suspension obtained after soaking the tea leaves was extracted by distillation under reduced pressure to obtain a tea aroma extract, and tea pulp was left. The distillation under reduced pressure was carried out at a vacuum degree of 55 Kpa and at a distillation extraction temperature of 79° C., and the temperature of condensed water was 4° C.

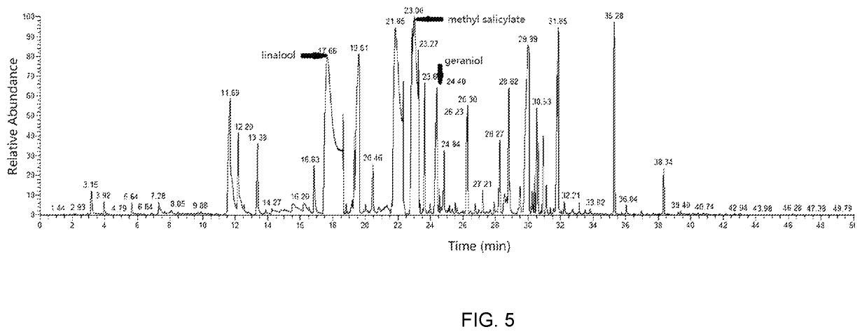

Aroma substances of the tea aroma extract extracted above were detected and analyzed with a gas chromatography-mass spectrometer, and the analysis chromatogram is shown in FIG. 5. The content of linalool in the tea aroma extract was measured as 1.803 μg/ml, the content of geraniol was 0.877 μg/ml, and the content of methyl salicylate was 1.762 μg/ml.

The tea pulp obtained above was centrifuged in a horizontal decanter centrifuge at a centrifugal speed of 3500 rpm, and filtered. The liquid was concentrated under reduced temperature at a vacuum degree of 85 Kpa and a temperature of 55° C., to have a volume that was ⅖ of its original volume, and then micro-filtration was performed at 22° C. with a ceramic membrane having a pore size of 0.2 μm, followed by ultrafiltration, to obtain a filtrate.

The filtrate obtained above was statically adsorbed with macroporous adsorption resin D101. 95% food-grade anhydrous alcohol solution having a volume 9 times the volume of the filtrate was added to the adsorbed filtrate; and the solution was precipitated at room temperature, centrifuged, and dried to obtain a tea theanine extract. The purity of the tea theanine extract was 42% as measured by a gas chromatography-mass spectrometer.

The extracted tea aroma extract and tea theanine extract were added to and mixed well with Chinese baijiu. The Chinese baijiu was of a strong-flavor type and had an alcohol content (v/v) of 40%. The tea wine contained 50 parts of the tea aroma extract, 3 parts of the tea theanine extract, 445 parts of Chinese baijiu, based on 500 parts by weight of tea wine, and the balance was water.

The tea wine prepared above can be subjected to processes of storage, filtration and packaging.

### Example 5

Intoxication Test on Mice

The use of the animal and the experimental protocol in this experiment were in compliance with the animal use standards of the Association for Assessment and Accreditation of Laboratory Animal Care International (AAALAC International), and had passed the review of the Institutional Animal Care and Use Committee (IACUC) of Shanghai Jiao Tong University. The IACUC license number is A2020093. The laboratory animal license number is SYXK (Shanghai) 2018-0028.

First, the mice were fasted for 12 hours (water was allowed), and then administered intragastrically with 0.12, 0.14, 0.16, 0.18, 0.20, 0.22, 0.24, 0.26, 0.28, and 0.3 ml/10 g·BW of 40% base wine (Chinese baijiu). The mental states and activities of the mice were observed, with righting reflex as an indicator of intoxication. Through comparison, a gavage dosage of 0.3 ml/10 g·BW, at which there were 90% intoxication rate and no individual death, was selected as the gavage dosage for evaluation. The intoxication tolerance time was the duration from the time of administrating the wine to the mice to the time of losing the righting reflex.

50 mice weighing 28-32 g were taken, and after one week of adaptive feeding, the mice were randomly divided into 5 groups, each with 10 mice. Among them, 4 groups of mice were given the tea wine of Examples 1-4, and 1 group was a control group and was given pure Chinese baijiu. The gavage dosage was 0.3 ml/10 g·BW. The intoxication tolerance time was calculated by observing the duration from the time of administrating the wine to the mice to the time of losing the righting reflex, and the results are shown in Table 1.

TABLE 1
Results of the Intoxication Test on Mice.

| | | Intoxication | Intoxication |
|---|---|---|---|
| | Gavage Dosage | Rate | Tolerance |
| Group | (ml/10 g · BW) | (100%) | Time |
| Tea wine prepared | 0.3 | 70 | 29.10 ± 9.20 |
| in Example 1 | | | |
| Tea wine prepared | 0.3 | 80 | 30.50 ± 13.03 |
| in Example 2 | | | |
| Tea wine prepared | 0.3 | 80 | 25.63 ± 7.60 |
| in Example 3 | | | |
| Tea wine prepared | 0.3 | 90 | 28.75 ± 6.50 |
| in Example 4 | | | |
| Control group (pure | 0.3 | 90 | 6.67 ± 3.93 |
| Chinese baijiu) | | | |

The experimental results in the above table show that the sober time of the four groups of mice administered with the tea wine of Examples 1˜4 of the present invention was significantly different compared with the sober time of the mice in the control group. The tolerance time for the control group was significantly shorter than that for the tea wine prepared in Examples 1 and 2 (p<0.05). Accordingly, the tea wine of the present disclosure can significantly improve the intoxication tolerance time. In addition, the intoxication rate of the mice administered with the tea wine of Examples 1-4 of the present invention was also generally lower than that of the control group.

The above examples only illustrate the principles and effects of, but not for limiting the present disclosure. Anyone familiar with this technology can modify or change the above examples without departing from the spirit and scope of the present disclosure. Therefore, all equivalent modifications or changes made by those with ordinary skills in the art without departing from the spirit and technical concept disclosed in the present disclosure should still be covered by the claims of the present disclosure.

What is claimed:

1. A method for preparing tea wine, the method comprising:
(1) crushing tea leaves and soaking the crushed tea leaves in a solvent to obtain a tea suspension;
(2) subjecting the tea suspension to distillation under reduced pressure to obtain a tea aroma extract and a remaining tea pulp;
(3) filtering the tea pulp to obtain a tea soup, and subjecting the tea soup to concentration under reduced pressure and filtering the tea soup to obtain a filtrate;
(4) adsorbing the filtrate with macroporous adsorption resin, then adding food-grade anhydrous alcohol, letting the resultant mixture stand, separating solid from the mixture and drying the solid to obtain a tea theanine extract; and
(5) mixing the tea aroma extract and the tea theanine extract with Chinese baijiu to obtain the tea wine.

2. The method according to claim 1, wherein the solvent in step (1) is pure water; preferably, the electrical conductivity of the pure water is 1-10 μs/cm, and preferably the weight of the pure water is 4-20 times the weight of the tea leaves.

3. The method according to claim 1, wherein the soaking in step (1) is performed at a temperature of 60-90° C. for preferably 0.5-2 hours.

4. The method according to claim 1, wherein the distillation under reduced pressure in step (2) is performed at a pressure of 30-76 Kpa, or preferably 43-68 Kpa.

5. The method according to claim 4, wherein the distillation under reduced pressure in step (2) is performed at a temperature of 65-90° C., preferably 75-85° C.; and preferably, the temperature of condensed water used in the distillation under reduced pressure is 2-8° C.

6. The method according to claim 1, wherein the tea aroma extract comprises one or more of linalool, geraniol, and methyl salicylate.

7. The method according to claim 6, wherein in the tea aroma extract, the content of the linalool is 1.0-3.0 μg/ml, the content of the geraniol is 0.5-3.0 μg/ml, and/or the content of the methyl salicylate is 1.5-3.0 μg/ml.

8. The method according to claim 1, wherein in step (3), the tea pulp is filtered by a horizontal decanter centrifuge, and preferably, the rotation speed of the horizontal decanter centrifuge is 1000-4000 rpm.

9. The method according to claim 1, wherein in step (3), the tea soup is subjected to the concentration under reduced pressure at a vacuum degree of 76-85 Kpa and a temperature of 55° C.-65° C.; and preferably, the tea soup is concentrated under reduced temperature to have a volume that is ⅕-½ of the original volume of the tea soup.

10. The method according to claim 9, wherein in step (3), the tea soup is subjected to concentration under reduced pressure followed by micro-filtration and ultrafiltration in sequence; and
preferably, the micro-filtration is performed with a ceramic membrane having a pore diameter of 0.1-0.5 μm and at a temperature of 20-30° C.

11. The method according to claim 1, wherein the macroporous adsorption resin in step (4) is D101 macroporous adsorption resin and/or AB-8 macroporous adsorption resin.

12. The method according to claim 1, wherein the purity of the anhydrous alcohol in step (4) is 95% or more, and the volume of the anhydrous alcohol is 2-10 times the volume of the filtrate adsorbed with the macroporous adsorption resin.

13. The method according to claim 1, wherein the alcohol content (v/v) of the Chinese baijiu in step (5) is 20-60%; and the Chinese baijiu is preferably a strong-flavor Chinese baijiu.

14. The method according to claim 1, wherein the tea leaves are at least one of black tea, oolong tea, or jasmine tea.

15. The method according to claim 1, wherein the method does not comprise a step of fermenting the tea leaves.

16. Tea wine prepared by the method according to claim 1.

17. The tea wine according to claim 16, wherein the tea wine contains 10-100 parts by weight of the tea aroma extract, 1-10 parts by weight of the tea theanine extract, and 380-480 parts by weight of Chinese baijiu.

18. The tea wine according to claim 17, wherein the tea wine contains 10-100 parts by weight of the tea aroma extract, 1-10 parts by weight of the tea theanine extract, and 380-480 parts by weight of Chinese baijiu, based on a total of 500 parts by weight of the tea wine, and the balance is water.
